(19) United States
(12) Patent Application Publication
(10) Pub. No.: US 2013/0187503 A1
(43) Pub. Date: Jul. 25, 2013

(54) SINGLE PHASE INDUCTION VIBRATION MOTOR

(71) Applicants: Yong Tae Kim, Suwon (KR); Kyung Su Park, Suwon (KR); Dong Su Moon, Suwon (KR)

(72) Inventors: Yong Tae Kim, Suwon (KR); Kyung Su Park, Suwon (KR); Dong Su Moon, Suwon (KR)

(73) Assignee: SAMSUNG ELECTRO-MECHANICS CO., LTD.

(21) Appl. No.: 13/440,561

(22) Filed: Apr. 5, 2012

(30) Foreign Application Priority Data
Jan. 20, 2012 (KR) 10-2012-0006923

(51) Int. Cl. H02K 23/04

(52) U.S. Cl. 310/154.45; 310/154.01

(57) ABSTRACT

There is provided a single phase induction vibration motor including: a bottom member having a shaft and a permanent magnet; a rotating member rotatably coupled to the shaft; a coil member disposed on the rotating member; and a magnetic member disposed on the rotating member to determine a stationary position of the rotating member, wherein the magnetic member is disposed to partially overlap with a region in which the permanent magnet is positioned, based on a horizontal surface of the rotating member.

### CROSS-REFERENCE TO RELATED APPLICATIONS

This application claims the priority of Korean Patent Application No. 10-2012-0006923 filed on Jan. 20, 2012, in the Korean Intellectual Property Office, the disclosure of which is incorporated herein by reference.

### BACKGROUND OF THE INVENTION

1. Field of the Invention

The present invention relates to a single phase induction vibration motor, and more particularly, to a single phase induction vibration motor capable of accurately determining a stationary position of a rotating member.

2. Description of the Related Art

Portable terminals including a mobile phone may include an audio output device (for example, a speaker) and a vibration output device (for example, a vibration motor) as output devices for transferring a response to an input signal of a user or an external signal.

Among these output devices, since the audio output device transfers an output signal through sound to a user, the user may easily recognize the output signal; however, people around the user may be inconvenienced.

On the other hand, since the vibration output device transfers an output signal to the user through tactile sensation (that is, vibrations), people around the user may not be inconvenienced; however, the vibration output device may be disadvantageous in that user recognition sensitivity is relatively low, current consumption is high, and a volume thereof is significant.

However, recently, as portable terminals including touch panels has become widespread, the use of a vibration motor (particularly, a single phase induction vibration motor), a kind of vibration output device, has gradually increased.

Meanwhile, in the vibration motor, a dead point in which rotational force of a rotating member is lost may be formed according to a structure in which a permanent magnet is disposed. This dead point may reduce a magnitude of vibrations, according to rotation of the rotating member and make the rotation of the rotating member substantially difficult.

In order to solve these problems, there are provided Patent Documents 1 and 2 according to the related art.

In Patent Documents 1 and 2, dead points may be significantly reduced by changing a shape of a permanent magnet.

However, in both of Patent Documents 1 and 2, two or more coil bundles are provided, such that it may be difficult to miniaturize and lighten a vibration motor. In addition, in Patent Documents 1 and 2, precision machining of a permanent magnet is required, such that it may not be easy to apply and commercialize technology disclosed in Patent Documents 1 and 2.

### RELATED ART DOCUMENT

(Patent Document 1) KR2002027713 A
(Patent Document 2) KR10-0385671 B1

### SUMMARY OF THE INVENTION

An aspect of the present invention provides a single phase induction vibration motor in which rotational movement of a rotating member may be smoothly performed.

According to an aspect of the present invention, there is provided a single phase induction vibration motor including: a bottom member having a shaft and a permanent magnet; a rotating member rotatably coupled to the shaft; a coil member disposed on the rotating member; and a magnetic member disposed on the rotating member to determine a stationary position of the rotating member, wherein the magnetic member is disposed to partially overlap with a region in which the permanent magnet is positioned, based on a horizontal surface of the rotating member.

The magnetic member may be disposed in a position at which the magnetic member forms an obtuse angle with the coil member, centered on the shaft.

The magnetic member may be disposed in a position at which the magnetic member forms an angle of 150 to 170 degrees with the coil member, centered on the shaft.

The magnetic member may have a bar shape or a horseshoe shape.

The magnetic member may have both ends disposed to overlap with the region in which the permanent magnet is positioned.

The single phase induction vibration motor may further include a mass member increasing a magnitude of weight eccentricity of the rotating member.

The mass member may be formed on the coil member.

The mass member may be formed at an edge of the rotating member.

The permanent magnet may include a plurality of first magnets each having a first polarity and a plurality of second magnets each having a second polarity, and the first and second magnets may be alternately disposed about the shaft.

The first and second magnets may have different cross-sectional areas.

The first and second magnets may have shapes in which the first and second magnets may be engaged with each other by a groove and a protrusion.

According to another aspect of the present invention, there is provided a single phase induction vibration motor including: a bottom member having a shaft; a permanent magnet formed on the bottom member and having a first polarity and a second polarity that are alternately disposed about the shaft; a rotating member rotatably coupled to the shaft; and a coil member disposed on the rotating member, wherein the permanent magnet is magnetized such that a boundary line between the first polarity and the second polarity forms an angle with respect to a virtual extended line extended in a radial direction of the rotating member.

The single phase induction vibration motor may further include a magnetic member disposed on the rotating member to determine a stationary position of the rotating member.

The magnetic member may be disposed in a position at which the magnetic member forms an obtuse angle with the coil member centered on the shaft.

The magnetic member may be disposed in a position at which the magnetic member forms an angle of 150 to 170 degrees with the coil member centered on the shaft.

The magnetic member may have a bar shape or a horseshoe shape.

The magnetic member may have both ends disposed to overlap with a region in which the permanent magnet is positioned.

The single phase induction vibration motor may further include a mass member increasing a magnitude of weight eccentricity of the rotating member.

The mass member may be formed on the coil member.

The mass member may be formed at an edge of the rotating member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a signal phase induction vibration motor according to an embodiment of the present invention;

FIG. 2 is a perspective view of a rotating member shown in FIG. 1;

FIGS. 3 through 5 are plan views describing a positional relationship between a magnetic member and a coil member shown in FIG. 1;

FIGS. 6 and 7 are plan views showing a modified shape of a magnetic member shown in FIG. 1;

FIGS. 8 and 9 are plan views showing a modified shape of a permanent magnet shown in FIG. 1;

FIG. 10 is a cross-sectional view of a signal phase induction vibration motor according to another embodiment of the present invention; and

FIG. 11 is a plan view showing a shape of a permanent magnet shown in FIG. 10.

### DETAILED DESCRIPTION OF THE EMBODIMENTS

According to embodiments of the present invention, a vibration motor having a small size and a light weight may be provided. To this end, the vibration motor according to the embodiments of the present invention may include a single coil member.

The vibration motor having a single coil member may be light as compared to a vibration motor including a plurality of coil members. Further, the single coil member may be widely disposed and accordingly, has a reduced thickness, such that a thickness of the vibration motor may be reduced.

In addition, in the vibration motor according to the embodiments of the present invention, a vibration magnitude may be increased. To this end, a coil member and a weight member may be disposed to overlap each other in the vibration motor.

In the vibration motor having this structure, since a magnitude of weight eccentricity of a rotating member may be increased by the coil member and the weight member, a magnitude of vibrations may be increased.

Therefore, the vibration motor according to the embodiment of the present invention may smoothly transfer a vibration signal to a user.

In addition, the vibration motor according to the embodiment of the present invention may have improved operational reliability. To this end, the vibration motor according to the embodiment of the present invention may further include a magnetic member.

In the vibration motor having this structure, since a stationary position of the rotating member may be determined by the magnetic member, a phenomenon that the rotating member (particularly, the coil member) is positioned at a dead point may be prevented.

Further, according to the embodiment of the present invention, since the rotating member (particularly, the coil member) may be positioned between a magnet having a first polarity and a magnet having a second polarity, the rotating member may rotate smoothly all the time.

Hereinafter, embodiments of the present invention will be described in detail with reference to the accompanying drawings.

In describing the present invention, terms indicating components of the present invention are named in consideration of functions of each component. Therefore, the terms should not be understood as being limited technical components of the present invention.

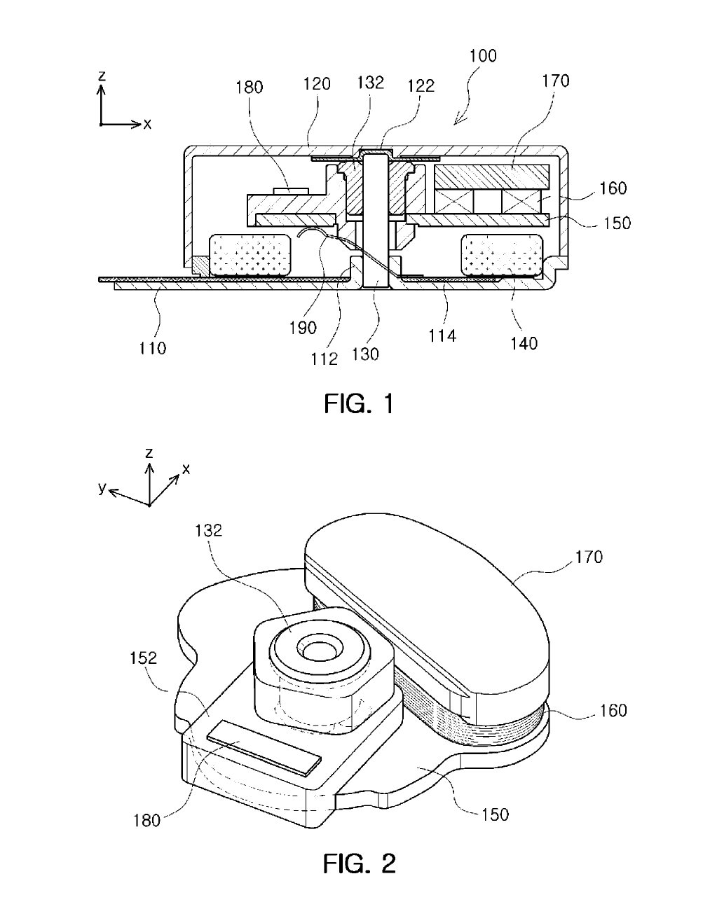

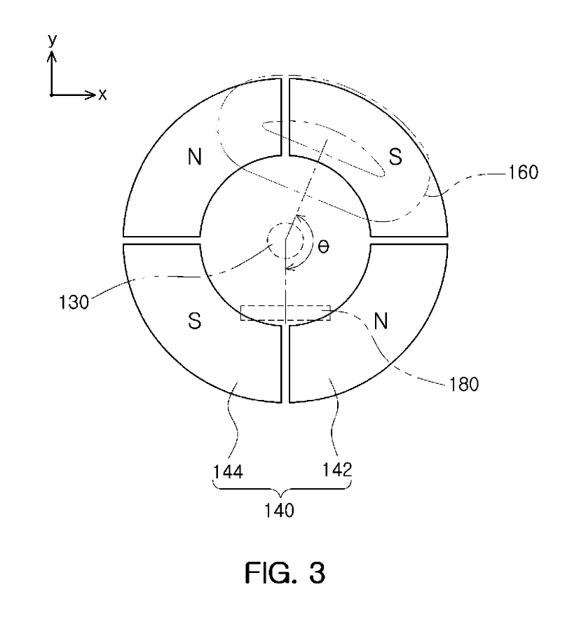

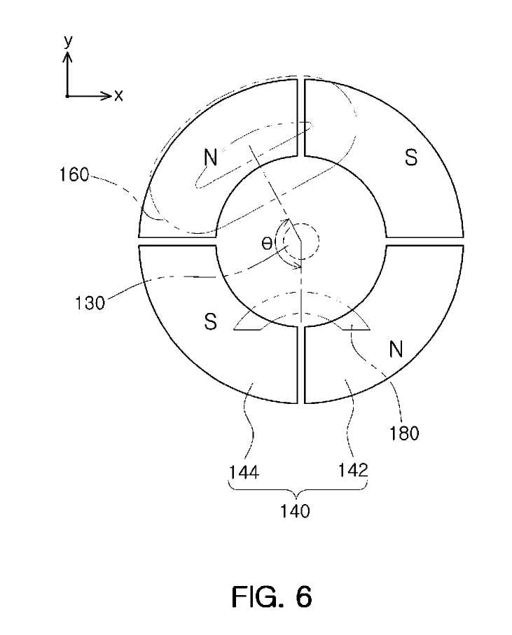

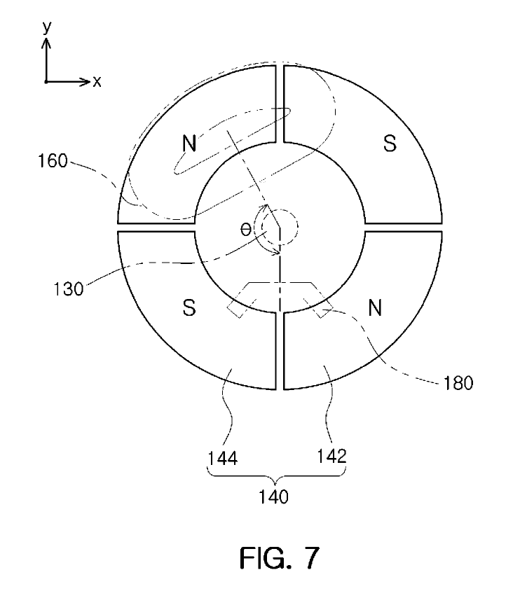

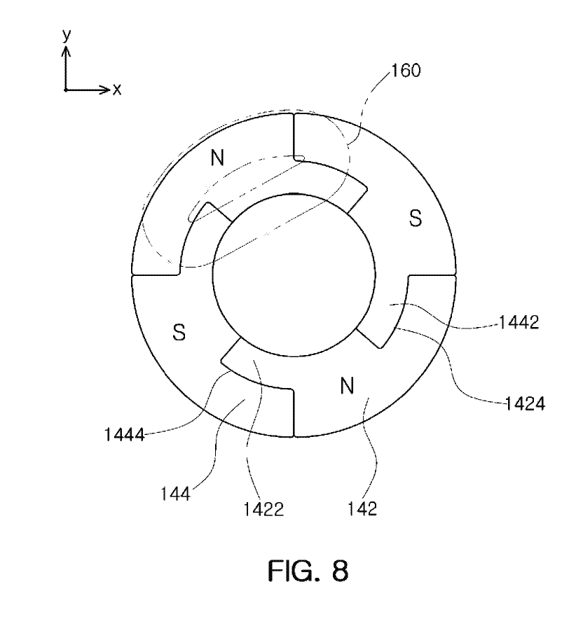

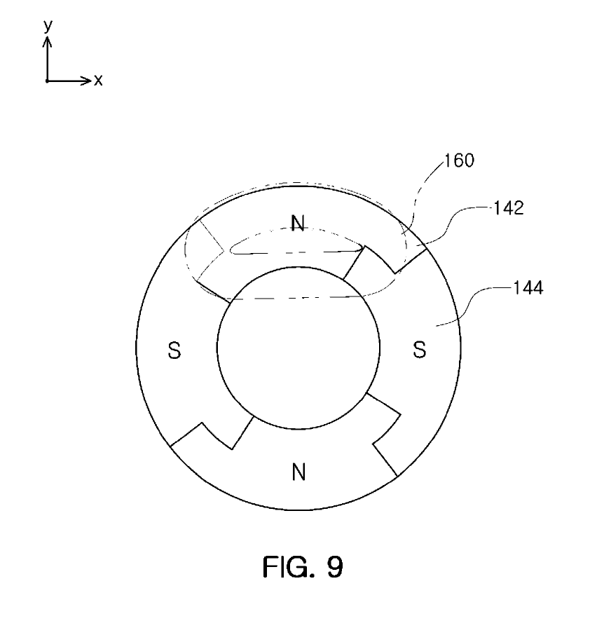

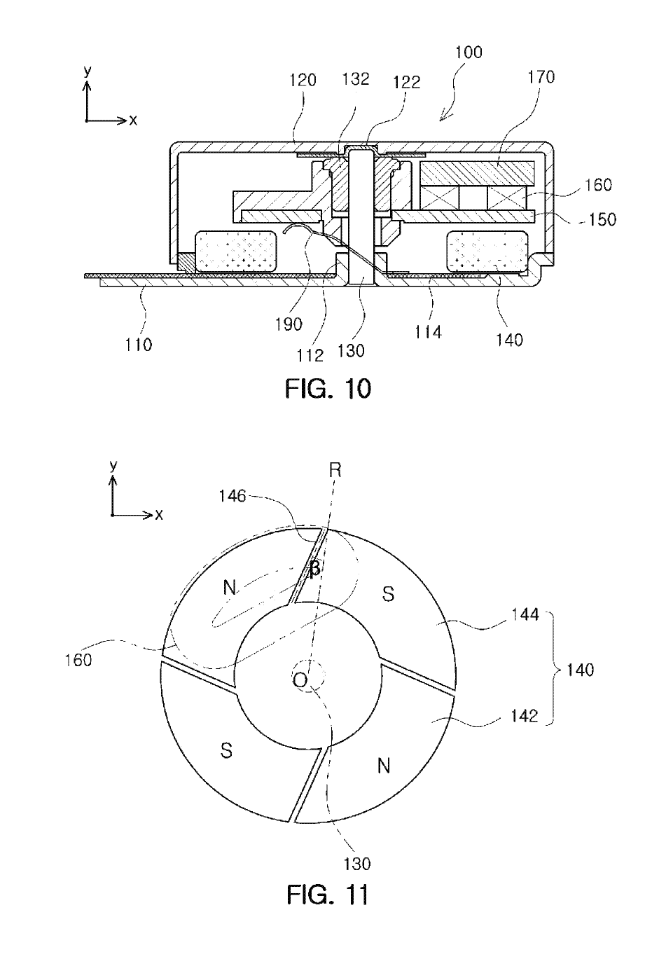

FIG. 1 is a cross-sectional view of a signal phase induction vibration motor according to an embodiment of the present invention; FIG. 2 is a perspective view of a rotating member shown in FIG. 1; FIGS. 3 through 5 are plan views describing a positional relationship between a magnetic member and a coil member shown in FIG. 1; FIGS. 6 and 7 are plan views showing a modified shape of a magnetic member shown in FIG. 1; FIGS. 8 and 9 are plan views showing a modified shape of a permanent magnet shown in FIG. 1; FIG. 10 is a cross-sectional view of a signal phase induction vibration motor according to another embodiment of the present invention; and FIG. 11 is a plan view showing a shape of a permanent magnet shown in FIG. 10.

A single phase induction vibration motor according to an embodiment of the present invention will be described with reference to FIGS. 1 through 9.

A single phase induction vibration motor 100 according to the embodiment of the present invention may include a bottom member 110, a cover member 120, a shaft 130, a permanent magnet 140, a rotating member 150, a coil member 160, a mass member 170, and a magnetic member 180. In addition, the single phase induction vibration motor 100 may selectively further include an elastic member 190.

The bottom member 110 may have a plate shape and be made of a metal material so as to have a predetermined strength. However, a shape and a material of the bottom member 110 are not limited thereto. Therefore, the bottom member 110 may have a shape corresponding to that of the cover member 120 and be formed of a material other than a metal.

The bottom member 110 may be manufactured by press processing. However, the bottom member 110 may be manufactured by a mold as needed.

The bottom member 110 may include a shaft support part 112 coupled to the shaft 130. More specifically, the shaft support part 112 may have a hole into which one end of the shaft 130 is inserted. However, the shape of the shaft support part 112 is not limited thereto, but may also be variously changed as long as it may support the shaft 130.

The bottom member 110 may include a circuit board 114.

The circuit board 114 may include a circuit pattern for supplying current to the coil member 160 and be attached to the bottom member 110. For example, the circuit board 114 may be attached to the bottom member 110 through an adhesive, or the like. Further, the bottom member 110 may have a groove having a shape corresponding to that of the circuit board 114 such that the circuit board 114 may be stably fixed to the one surface of the bottom member 110.

The cover member 120 may be coupled to the bottom member 110. For example, the cover member 120 and the bottom member 110 may be coupled to each other by welding, caulking, curling, or the like.

The cover member 120 may have a cylindrical shape in which a lower surface thereof is opened and be formed of a metal material having high impact resistance. However, a shape and a material of the cover member 120 are not limited thereto, but may be variously changed. For example, the cover member 120 may have an angular pillar shape and be formed of a material other than a metal.

The cover member 120 may have a groove 122 into which the other end of the shaft 130 is fixed. Here, the groove 122 may have a hole shape in which the other end of the shaft 130 is entirely accommodated or a concave shape in which the other end of the shaft 130 is partially accommodated. An adhesive may be applied to the groove 122 in order to fix the shaft 130 thereto. Meanwhile, in the case in which the shaft 130 may be stably fixed by the shaft support part 112, the groove 122 of the cover member 120 may be omitted.

The shaft 130 may be coupled to the bottom member 110 and may also be selectively coupled to the cover member 120.

The shaft 130 may penetrate through the rotating member 150 and be a rotational center of the rotating member 150. Here, the shaft 130 may include a bearing 132 so as to allow the rotating member 150 to freely rotate. The bearing 132 may be coupled to the rotating member 150.

The permanent magnet 140 may be disposed on the bottom member 110. More specifically, the permanent magnet 140 may be disposed in a circular manner based on the shaft 130.

The permanent magnet 140 may have a plurality of magnets 142 and 144 having different polarities. For example, the permanent magnet 140 may include a plurality of first magnets 142 having a first polarity (an N pole) and a plurality of second magnets 144 having a second polarity (an S pole) as shown in FIG. 3. Here, the number of first magnets 142 is the same as that of second magnets 144.

The first and second magnets 142 and 144 may be alternately disposed about the shaft 130. That is, each of the first magnets 142 may be disposed to be adjacent to the second magnets 144, and each of the second magnets 144 may be disposed to be adjacent to the first magnets 142.

The rotating member 150 may be rotatably coupled to the shaft 130. In addition, the rotating member 150 may rotate around the shaft 130. To this end, the rotating member 150 and the shaft 130 may include the bearing 132 disposed therebetween in order to allow for a rotation of the rotating member 150.

The rotating member 150 may be provided with a circuit pattern connected to the coil member 160. Alternatively, the rotating member 150 may be a substrate on which the circuit pattern is formed.

The rotating member 150 may be asymmetrical with respect to the shaft 130. For example, the rotating member 150 may have a fan shape or another shape in which it has a center of mass that does not coincide with the center of the shaft 130.

The rotating member 150 may include a fixed member 152. In addition, the rotating member 150 may include the coil member 160, the mass member 170, and the magnetic member 180 formed thereon.

The fixed member 152 may be formed of a resin material and may be formed integrally with the rotating member 150 while accommodating the bearing 132 therein. For example, the fixed member 152 may be formed on the rotating member 150 having the bearing 132 mounted thereon by an insert injection molding method.

The fixed member 152 may absorb impacts generated during the rotation of the rotating member 150. To this end, the fixed member 152 may be formed of a material capable of easily absorbing impacts. For example, the fixed member 152 may be formed of rubber, a resin, or the like.

The coil member 160 may be mounted on the rotating member 150 and be connected to a circuit pattern (not shown) formed on the rotating member 150. More specifically, the coil member 160 may be formed on a relatively large portion of the rotating member 150.

The coil member 160 may be formed of a group of coil bundles. The coil member 160 formed of a group of coil bundles may allow for a simplified structure of the single phase induction vibration motor 100 and a reduced weight of the single phase induction vibration motor 100.

The coil member 160 may have an area in which the coil member 160 may interact with at least two magnets 142 and 144 having different polarities when the rotating member 150 is stationary. In the case in which the coil member 160 is formed to correspond to the magnets 142 and 144 having different polarities all the time, as described above, the rotating member 150 in a stationary state may smoothly rotate.

That is, in the case in which the coil member 160 may simultaneously face at least two magnets 142 and 144, since magnetic force having a first polarity and magnetic force having a second polarity may simultaneously act on the coil member 160, the rotating member 150 in the stationary state may easily rotate.

The mass member 170 may be formed on the coil member 160. More specifically, the mass member 170 may be formed integrally with the coil member 160 to increase a magnitude of weight eccentricity of the rotating member.

For example, the mass member 170 may be formed of a metal material including tungsten. However, the mass member 170 is not limited to being formed of a metal, but may be formed of a material other than the metal.

The mass member 170 may be coupled to the coil member 160 by an adhesive. Alternatively, the mass member 170 may be formed integrally with the coil member 160. For example, the mass member 170 may be formed of a coil bundle, similar to the coil member 160. Alternatively, the mass member 170 may be insert injection molded with the coil member 160. In this case, the mass member 170 may be formed of any material as long as it may be insert injection molded.

Meanwhile, although the accompanying drawings have shown a case in which the mass member 170 is formed on the coil member 160, the mass member 170 may be formed at an edge of the rotating member 150 so as to allow for the slimming of the single phase induction vibration motor.

The magnetic member 180 may be formed on the rotating member 150.

The magnetic member 180 may suppress the rotating member 150 from being biased toward one side due to weights of the coil member 160 and the mass body 170. The magnetic member 180 may stop the rotating member 150 at a predetermined position.

To this end, the magnetic member 180 may be a magnetic material or a magnet having a polarity. For example, the magnetic member 180 may be a magnet having first and second polarities.

The magnetic member 180 may be disposed on the rotating member 150 such that it is substantially opposed to the coil member 160. In addition, a predetermined angle may be formed by the magnetic member 180 and the coil member 160, centered on the shaft 130 as shown in FIGS. 3 to 5.

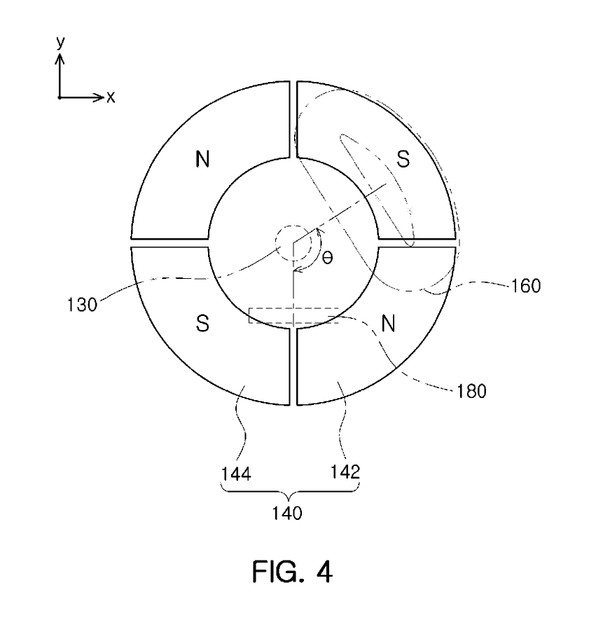

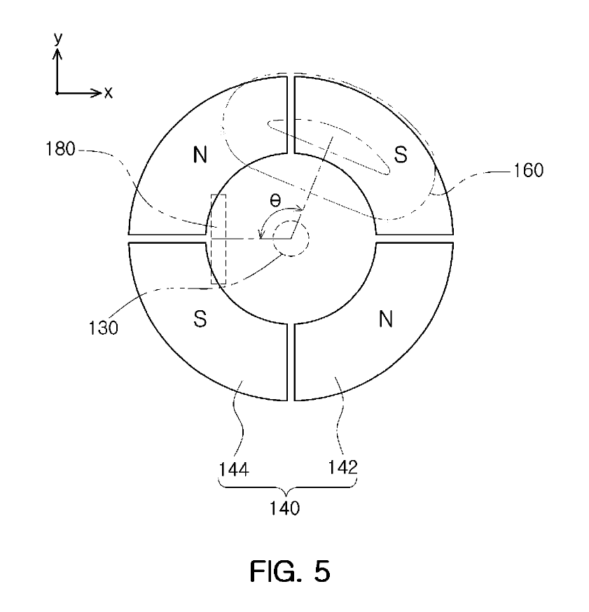

For example, the magnetic member 180 may be disposed in a position at which it forms an angle in a range of 150 to 170 degrees with the coil member 160 (See FIG. 3), be disposed in a position at which it forms an angle in a range of 130 to 150 degrees with the coil member 160 (See FIG. 4), or be disposed in a position at which it forms an angle in a range of 100 to 120 degrees with the coil member 160 (See FIG. 5).

Here, in a structure shown in FIG. 3, since the magnet member 180 and the coil member 160 are disposed such that they are substantially symmetrical to each other, it is easy to maintain the balance of load acting on the rotating member 150. Unlike this, in a structure shown in FIG. 5, since the magnetic member 180 and the coil member 160 are intensively disposed at one place, the rotating member may be miniaturized.

Meanwhile, the magnetic member 180 may be disposed to partially overlap with a region in which the permanent magnet 140 is formed, when viewed based on plan views (See FIGS. 3 through 7). For example, a half of the entire area (based on an X-Y plane) of the magnetic member 180 may be disposed to partially overlap with a region in which the permanent magnet 140 is formed.

This structure may facilitate determination of the stationary position of the rotating member 150 by interaction between the magnetic member 180 and the permanent magnet 140 while suppressing the rotating member 150 from being biased toward one side due to strong magnetic force between the magnetic member 180 and the magnets 142 and 144.

The magnetic member 180 may have a curved shape or a horseshoe shape as shown in FIGS. 6 and 7. Since the magnetic member 180 having this shape may have magnetic flux concentrated on both ends thereof, the stationary position of the rotating member 150 may be effectively fixed. Here, both ends of the magnetic member 180 may be disposed to partially overlap with the region in which the permanent magnet 140 is formed.

The magnetic member 180 disposed as described above may suppress a bias phenomenon of the rotating member 150 while maintaining a predetermined angle with the coil member 160. In addition, the magnetic member 180 may stop the rotating member 150 (particularly, the coil member 160) at a position (for example, between the magnet 142 having the first polarity and the magnet 144 having the second polarity) desired by a designer through the interaction with the magnets 142 and 144.

The elastic member 190 may be disposed on the bottom member 110 and be connected to the rotating member 150. More specifically, the elastic member 190 may electrically connect the circuit board 114 of the bottom member 110 and the circuit pattern of the rotating member 150 to each other.

The elastic member 190 may be a brush alternatively supplying the coil member 160 with a current in a first direction and a current in a second direction. To this end, the elastic member 190 may be formed of two separated structures.

In addition, the elastic member 190 may support the rotating member 150. To this end, the elastic member 190 may be formed of a metal material having a predetermined elasticity. However, the elastic member 190 is not limited to being formed of the metal material, but may be formed of other materials including a conductive material.

The single phase induction vibration motor 100 configured as described above may stop the rotating member 150 between the first magnet 142 having the first polarity and the second magnet 144 having the second polarity or at a position at which the rotating member 150 simultaneously receives the magnetic force of the magnets 142 and 144, all the time. Therefore, the rotating member 150 in a stationary state may smoothly rotate.

Meanwhile, according to the embodiment, the permanent magnet 140 may be changed to have shapes shown in FIGS. 8 and 9. That is, the permanent magnet 140 may include the magnets 142 and 144 having protrusions 1422 and 1442 and grooves 1424 and 1444. Here, the first and second magnets 142 and 144 may have different cross-sectional areas.

The magnets 142 and 144 configured as described above may allow for a reduction in a dead point area in which only magnetic force having one polarity may be provided to the rotating member 150, such that the rotation of the rotating member 150 may be smoothly performed.

Hereinafter, a single phase induction vibration motor according to another embodiment of the present invention will be described with reference to FIGS. 10 and 11.

The signal phase induction vibration motor 100 according to another embodiment of the present invention may be different from the single phase induction vibration motor 100 according to the foregoing embodiment of the present invention, in terms of a shape of the permanent magnet 140.

The permanent magnet 140 may include the first magnets 142 having a first polarity and the second magnets 144 having a second polarity. Here, the first and second magnets 142 and 144 may be disposed in a circular manner, as shown in FIG. 11. In addition, a boundary line 146 on which each first magnet 142 and each second magnet 144 are in contact with each other may form an angle with an extended line (O-R) extended from a center O of the shaft 130 in a radial direction. Here, an angle φ formed by the boundary line 146 and the extended line (O-R) may be an acute angle and be in a range of 10 to 30 degrees.

The permanent magnet 140 formed as described above may reduce a dead point area. Therefore, according to another embodiment, the magnetic member 180 may be omitted.

In addition, since the permanent magnet 140 according to another embodiment of the present invention does not include a separate protrusion and groove, it may be easily processed and manufactured and be easily applied to a product. Therefore, according to the embodiment, a manufacturing cost of the single phase induction vibration motor may be reduced.

As set forth above, according to the embodiments of the present invention, the single phase induction vibration motor may be miniaturized and have significantly increased vibratory efficiency.

While the present invention has been shown and described in connection with the embodiments, it will be apparent to those skilled in the art that modifications and variations can be made without departing from the spirit and scope of the invention as defined by the appended claims.

What is claimed is:

1. A single phase induction vibration motor comprising:
a bottom member having a shaft and a permanent magnet;
a rotating member rotatably coupled to the shaft;
a coil member disposed on the rotating member; and
a magnetic member disposed on the rotating member to determine a stationary position of the rotating member,
wherein the magnetic member is disposed to partially overlap with a region in which the permanent magnet is positioned, based on a horizontal surface of the rotating member.

2. The single phase induction vibration motor of claim 1, wherein the magnetic member is disposed in a position at which the magnetic member forms an obtuse angle with the coil member, centered on the shaft.

3. The single phase induction vibration motor of claim 1, wherein the magnetic member is disposed in a position at which the magnetic member forms an angle of 150 to 170 degrees with the coil member, centered on the shaft.

4. The single phase induction vibration motor of claim 1, wherein the magnetic member has a bar shape or a horseshoe shape.

5. The single phase induction vibration motor of claim 1, wherein the magnetic member has both ends disposed to overlap with the region in which the permanent magnet is positioned.

6. The single phase induction vibration motor of claim 1, further comprising a mass member increasing a magnitude of weight eccentricity of the rotating member.

7. The single phase induction vibration motor of claim 6, wherein the mass member is formed on the coil member.

8. The single phase induction vibration motor of claim 6, wherein the mass member is formed at an edge of the rotating member.

9. The single phase induction vibration motor of claim 1, wherein the permanent magnet includes a plurality of first magnets each having a first polarity and a plurality of second magnets each having a second polarity, and
the first and second magnets are alternately disposed about the shaft.

10. The single phase induction vibration motor of claim 9, wherein the first and second magnets have different cross-sectional areas.

11. The single phase induction vibration motor of claim 10, wherein the first and second magnets have shapes in which the first and second magnets are engaged with each other by a groove and a protrusion.

12. A single phase induction vibration motor comprising:
a bottom member having a shaft;
a permanent magnet formed on the bottom member and having a first polarity and a second polarity that are alternately disposed about the shaft;
a rotating member rotatably coupled to the shaft; and
a coil member disposed on the rotating member,
wherein the permanent magnet is magnetized such that a boundary line between the first polarity and the second polarity forms an angle with respect to a virtual extended line extended in a radial direction of the rotating member.

13. The single phase induction vibration motor of claim 12, further comprising a magnetic member disposed on the rotating member to determine a stationary position of the rotating member.

14. The single phase induction vibration motor of claim 13, wherein the magnetic member is disposed in a position at which the magnetic member forms an obtuse angle with the coil member centered on the shaft.

15. The single phase induction vibration motor of claim 13, wherein the magnetic member is disposed in a position at which the magnetic member forms an angle of 150 to 170 degrees with the coil member centered on the shaft.

16. The single phase induction vibration motor of claim 13, wherein the magnetic member has a bar shape or a horseshoe shape.

17. The single phase induction vibration motor of claim 13, wherein the magnetic member has both ends disposed to overlap with a region in which the permanent magnet is positioned.

18. The single phase induction vibration motor of claim 12, further comprising a mass member increasing a magnitude of weight eccentricity of the rotating member.

19. The single phase induction vibration motor of claim 18, wherein the mass member is formed on the coil member.

20. The single phase induction vibration motor of claim 18, wherein the mass member is formed at an edge of the rotating member.
